(19) United States
(12) Patent Application Publication
(10) Pub. No.: US 2003/0227256 A1
(43) Pub. Date: Dec. 11, 2003

(54) Automatic actuation of device according to UV intensity

(75) Inventors: Wen-Wei Su, Taoyuan (TW); Kuei-Hung Chen, Taoyuan (TW); Shun-Hsiang Hsiao, Taoyuan (TW)

Correspondence Address: BACON & THOMAS, PLLC, 625 SLATERS LANE, FOURTH FLOOR, ALEXANDRIA, VA, 22314

(73) Assignee: EXON SCIENCE INC., Taoyuan (TW)

(21) Appl. No.: 10/453,648

(22) Filed: Jun. 4, 2003

(30) Foreign Application Priority Data
Jun. 7, 2002 (TW) 091112346

(51) Int. Cl. H01J 1/62; H01J 63/04

(52) U.S. Cl. 313/510

(57) ABSTRACT

A thin-film electro-luminescence display includes a light-emitting layer for emitting light in response to an alternate current voltage; a back electrode layer disposed at a side of the light-emitting layer; and a light-transmitting conductive layer disposed at another side of the light-emitting layer opposite to the back electrode layer, and cooperating with the back electrode layer to provide the alternate current voltage for the light-emitting layer. The light-emitting layer and the light-transmitting conductive layer are patterned to define a plurality of independent display zones, and when the alternate current voltage is applied between the back electrode layer and the light-transmitting conductive layer in a specified portion of the display zones, light is emitted by the light-emitting layer in the specified portion of display zones to show a specific character.

### FIELD OF THE INVENTION

The present invention relates to a thin-film display, and more particularly to a thin-film electro-luminescence (EL) display for use in a vehicular rearview mirror or windscreen.

### BACKGROUND OF THE INVENTION

Due to the increasing complexity of traffic situations and vehicular functions, there are a lot of information and data required to be timely provided for the reference of the driver. Conventionally, the dashboard in the vehicle is used to show various informations. However, frequently keeping eyes on the dashboard while driving is dangerous. Therefore, an attempt to find a better place to show the information arises. Mounting to a rearview mirror is one of the best choices.

Please refer to FIGS. 1A, B and C which schematically show the appearance and structure of a conventional rearview mirror with an information display function. In FIG. 1A, it is schematically shown the rearview mirror reflects the image behind the vehicle for the driver's reference. In FIG. 1B, it is schematically shown the rearview mirror not only reflects the image behind the vehicle but also performs information-displaying function, e.g. turning direction indication, for the driver's reference. In order to exhibit the above functions, the structure of the rearview mirror is as shown in FIG. 1C, and principally comprises a light-transmitting glass 10, a reflective layer 11 and a display 12. The light-transmitting glass 10 and reflective layer 11 function as a reflection mirror. In addition, the thickness of the reflective layer 11 should be properly controlled so as to allow the light from the actively light-emitting display 12 to penetrate through the reflective layer 11 and the light-transmitting glass 10 and then reach the driver's eyes. By this way, both the reflected image and the displayed information can be shown. Conventionally, a liquid crystal display (LCD) or a light-emitting-diode (LED) display is used as the display 12. So far, the LCD or LED display has been too large for a rearview mirror housing. Therefore, the assembling process is uneasy to be implemented, and the product is bulky.

### SUMMARY OF THE INVENTION

Therefore, an object of the present invention relates to a compact thin-film display, which is adapted for use in a rearview mirror to show both reflected image and active information.

An aspect of the present invention relates to a thin film display. The thin film display comprises a light-emitting layer for emitting light in response to an alternate current voltage; a back electrode layer disposed at a side of the light-emitting layer; and a light-transmitting conductive layer disposed at another side of the light-emitting layer opposite to the back electrode layer, and cooperating with the back electrode layer to provide the alternate current voltage for the light-emitting layer. The light-emitting layer and the light-transmitting conductive layer are patterned to define a plurality of independent display zones, and when the alternate current voltage is applied between the back electrode layer and the light-transmitting conductive layer in a specified portion of the display zones, light is emitted by the light-emitting layer in the specified portion of display zones to show a specific character.

Preferably, the thin film display further comprises a dielectric layer formed between the back electrode layer and the light-emitting layer.

For being used in a vehicle, the light-transmitting conductive layer, the light-emitting layer and the back electrode layer are formed on a transparent substrate of a vehicle.

For example, the transparent substrate is a rearview mirror or windscreen.

Preferably, the thin film transistor further comprises a control circuit electrically connected to the light-emitting layer and the light-transmitting conductive layer, determining the specified portion of display zones according to the specific character to be shown, and selectively providing the alternate current voltage for the specified portion of display zones.

Preferably, the thin film display further comprises a lower light-transmitting protective film formed on the back electrode layer; and an upper light-transmitting protective film formed on the light-transmitting conductive layer.

Preferably, the light-emitting layer is an electro-luminescence (EL) layer.

Preferably, the independent display zones include a plurality of sets of seven-segment display zones.

A second aspect of the present invention relates to a thin film electro-luminescence (EL) display module, which comprises a light-emitting layer for emitting light in response to an alternate current voltage; a back electrode layer disposed at a side of the light-emitting layer; a light-transmitting conductive layer disposed at another side of the light-emitting layer opposite to the back electrode layer, and cooperating with the back electrode layer to provide the alternate current voltage for the light-emitting layer, the light-emitting layer and the light-transmitting conductive layer being patterned to define a plurality of independent display zones; a flexible and light-transmitting housing for accommodating therein the back electrode layer, the light-emitting layer and the light-transmitting conductive layer; and a control circuit electrically connected to the light-emitting layer and the light-transmitting conductive layer, determining the specified portion of display zones according to a specific character to be shown, and selectively providing the alternate current voltage for the specified portion of display zones to show the specific character.

Preferably, the flexible and light-transmitting housing comprises a lower flexible and light-transmitting protective film formed on the back electrode layer; and an upper flexible and light-transmitting protective film formed on the light-transmitting conductive layer. For example, the lower and upper flexible and light-transmitting protective films are made of PET (polyethylene terephthalate) resin.

A third aspect of the present invention relates to a vehicular rearview mirror, which comprises a reflective mirror for showing image of an object; and at least one thin-film display unit attached to the reflective mirror for showing an active information. The thin-film electro-luminescence display unit comprises a plurality of independent display zones, the plurality of independent display zones are selectively activated to emit light so as to show a specific character.

Preferably, the thin-film electro-luminescence display unit comprises a light-emitting layer for emitting light in response to an alternate current voltage; a back electrode layer disposed at a side of the light-emitting layer; and a light-transmitting conductive layer disposed at another side of the light-emitting layer opposite to the back electrode layer, and cooperating with the back electrode layer to provide the alternate current voltage for the light-emitting layer. The light-emitting layer and the light-transmitting conductive layer are patterned to define the plurality of independent display zones, and when the alternate current voltage is applied between the back electrode layer and the light-transmitting conductive layer in a specified portion of the display zones, light is emitted by the light-emitting layer in the specified portion of display zones to show the specific character.

In an embodiment, the specified portion of display zones is determined by a built-in control circuit.

In another embodiment, the specified portion of display zones is determined by a card inserted into the vehicular rearview mirror.

In an embodiment, the vehicular rearview mirror comprises a plurality of thin-film display units attached to different positions of the reflective mirror for showing different active informations.

### BRIEF DESCRIPTION OF THE DRAWINGS

The present invention may best be understood through the following description with reference to the accompanying drawings, in which:

FIGS. 1A, B and C which schematically show the appearance and structure of a conventional rearview mirror with an information display function;

FIG. 2 is a cross-sectional structure diagram of a preferred embodiment of a thin-film electro-luminescence display according to the present invention;

FIG. 3 is a schematic diagram showing a plurality of independent and separate display zones defined according to the present invention;

FIG. 4A is a schematic diagram showing an exemplified use of a thin-film electro-luminescence display in a vehicular rearview mirror;

FIG. 4B is a schematic diagram showing an exemplified use of a thin film electro-luminescence display in the windscreen; and

FIG. 5 is a cross-sectional structure diagram of another preferred embodiment of a thin-film electro-luminescence display according to the present invention.

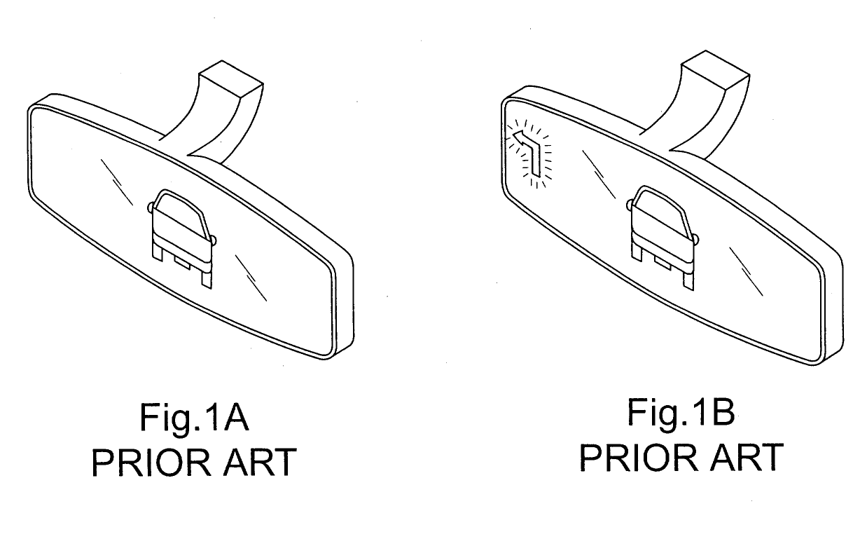

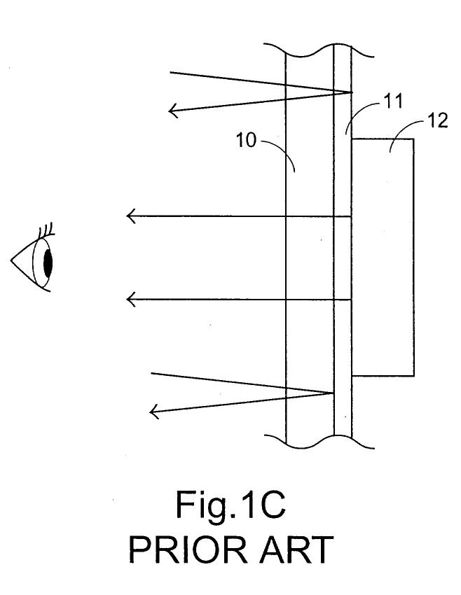

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only; it is not intended to be exhaustive or to be limited to the precise form disclosed.

In order to solve the problem encountered by using a bulky LCD or LED display in the prior art, the present invention uses a thin-film electro-luminescence (EL) display to reveal information. Conventionally, a thin-film electro-luminescence display is used to show a fixed pattern. Due to the requirement on providing changing or various information, the present invention provides a thin-film electro-luminescence display able to reveal character information and data.

It is to be noted that the term “character” used herein indicates a digit, an alphabet, a pattern or any other suitable expression of information.

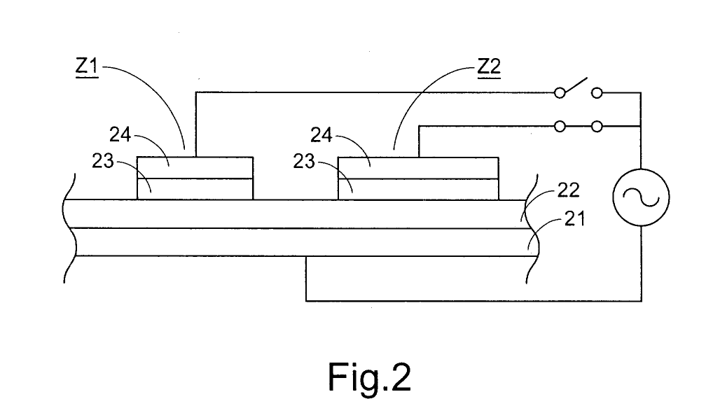

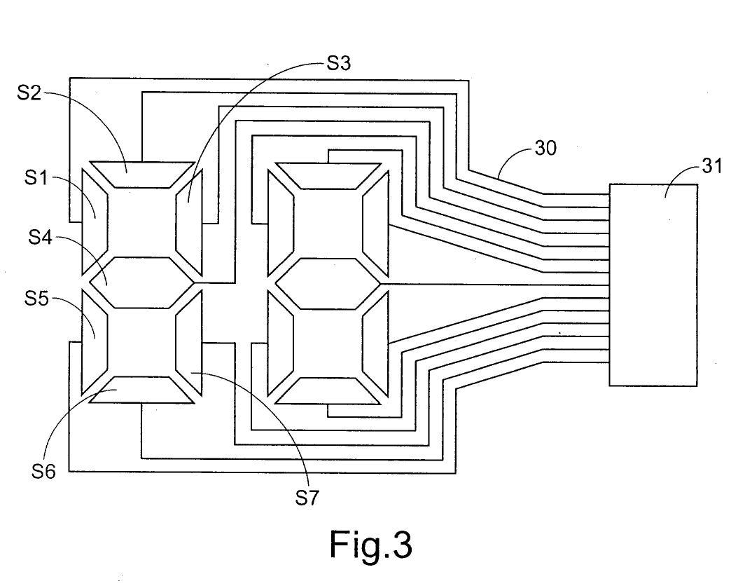

Please refer to FIG. 2, which is a cross-sectional structure diagram of a preferred embodiment of a thin-film electro-luminescence display according to the present invention. The thin-film electro-luminescence display comprises a back electrode layer 21, a dielectric layer 22, a light-emitting layer 23 and a light-transmitting conductive layer 24. The light-emitting layer 23 and the light-transmitting conductive layer 24 are patterned to define a plurality of separate electro-luminescence (EL) display zones, e.g. Z1 and Z2. Each of the EL display zones is independently conducted. When an alternate current voltage is applied between the back electrode layer 21 and an EL display zone being conducted, e.g. Z2, light is emitted from the light-emitting layer 23 in that display zone. Which one or ones of the EL display zones should be conducted is particularly arranged in order to combine the lightening zones to show a specific character. Examples will be given as follows with reference to FIG. 3.

Further referring to FIG. 3, a plurality of independent and separate EL display zones are shown as seven-segment arrangement. The light-emitting layer 23 and the light-transmitting conductive layer 24 are patterned into a plurality of sets of EL display zones S1˜S7, and each zone is electrically connected to a control circuit 31 via a conducting line 30. According to the information to be displayed, the control circuit 31 provides an alternate current between the back electrode layer 21 and designated EL display zones to activate the light-emitting layer 23 in those designated display zones to emit light. Therefore, a specific character associated with the desired information is displayed.

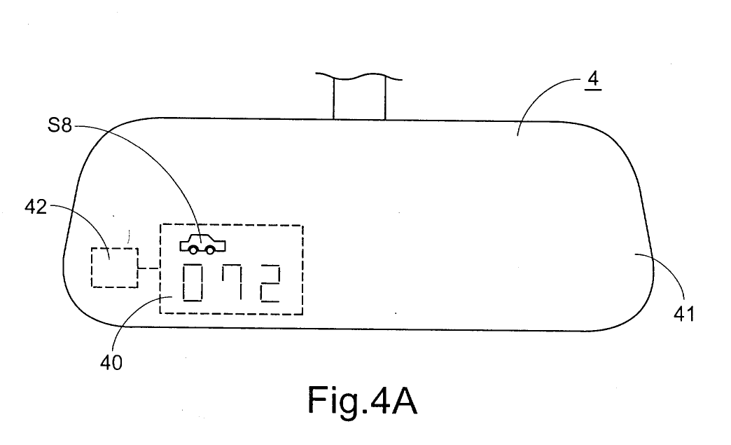

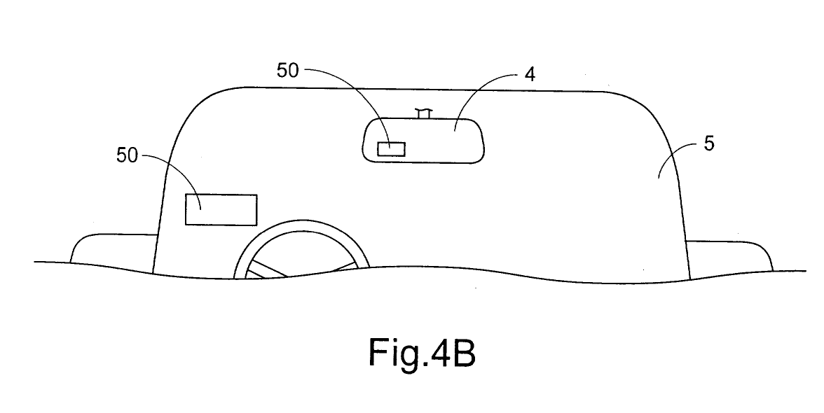

For example, as shown in FIG. 4A, a thin-film electro-luminescence display 40 according to the present invention can be arranged on a rearview mirror 4 of a vehicle to show current speed of the vehicle. First of all, the light-transmitting conductive layer 24 and the light-emitting layer 23 are sequentially applied onto the back of the light-transmitting substrate 41 of the rearview mirror, which is generally made of glass or acrylic plastic, and patterned to for the EL display zones S and conductive lines 30, e.g. those shown in FIG. 3. Subsequently, the dielectric layer 22, the back electrode layer 21 and other conductive lines are formed to complete the provision of the thin-film electro-luminescence display 40 to the rearview mirror 40. Then, as described above, by providing an alternate current between the back electrode layer 21 and designated EL display zones under the control of the control circuit 31, light-emitting layer 23 in those designated display zones will be activated to emit light, thereby showing digits representing the speed of the vehicle.

In addition to speed, other driving data such as revolving rate, heading direction, turning indication, door safety check or illumination check, or other useful data such as temperature, UV index, stereo volume, radio channel or telephone number, etc. can also be shown. The above information can be obtained by properly designing the control circuit 31 and patterns of the display zones, and connecting the control circuit 31 to associated devices such as various sensors, stereo, radio and/or handsfree cellular phone, etc. The connection of the control circuit 31 to the associated device can be implemented via cables or vehicular digital bus such as controller area network (CAN) bus or vehicle area network (VAN) bus.

A large one or more than one thin-film electro-luminescence display 40 can be arranged on the rearview mirror 4 to provide two or more different information on different positions of the rearview mirror 4. Alternatively, the same thin-film electro-luminescence display 40 can be switched to show different information. Referring to FIG. 4A again, in addition to digits 072, a mark S8 indicating that speed information is currently shown can be pre-patterned as one of the EL display zones, and the light-emitting layer 23 in the display zone S8 is activated along with light-emitting layer 23 in the display zones for showing the digits 072. When another data is to be revealed, a different mark at another display zone can be shown along with the digits associated with the data. All the information to be shown is controlled by the control circuit 31 by way of properly patterning the display zones and selectively activating the light-emitting layer 23 in those display zones. All the above-mentioned functions can be performed by a single control circuit 31. Alternatively, the functions can be independently controlled and performed by inserting various cards. In order to achieve this purpose, a card socket 42 should be provided on the rearview mirror housing and electrically connected to the control circuit 31.

Herein, an interior rearview mirror is illustrated for exemplification only, and a similar designed can be applied to an exterior rearview mirror, which is not to be redundantly described.

In the embodiment shown in FIG. 4A, the back electrode layer 21, dielectric layer 22, light-emitting layer 23 and light-transmitting conductive layer 24 are directly formed on the rearview mirror 4. It is advantageous compared to the conventional LCD or LED display due to small thickness and high compatibility to the manufacturing process of the rearview mirror. In another embodiment according to the present invention, the thin-film electro-luminescence display can be made as a module, and selectively attached to any proper position on the vehicle. For example, the thin-film electro-luminescence display module 50 can be adhered to the front surface of the rearview mirror 4 or windscreen 5, as shown in FIG. 4B.

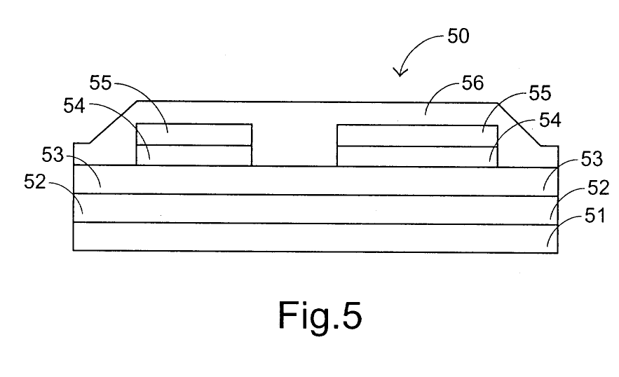

Please refer to FIG. 5, the thin-film electro-luminescence display module 50 includes a lower light-transmitting protective film 51, a back electrode layer 52, a dielectric layer 53, a light-emitting layer 54, a light-transmitting conductive layer 55 and an upper light-transmitting protective film 56. The light-emitting layer 54 and the light-transmitting conductive layer 55 are patterned to define a plurality of separate electro-luminescence (EL) display zones. Each of the EL display zones is independently conducted. When an alternate current voltage is applied between the back electrode layer 52 and an EL display zone being conducted, light is emitted from the light-emitting layer 54 in that display zone. Which one or ones of the EL display zones should be conducted is particularly arranged in order to combine the lightening zones to show a specific character. The material for forming the layers of the thin-film electro-luminescence display module 50 is preferably flexible in order to readily conform to the shape of the rearview mirror or windscreen to be attached to. In addition, the material for forming the layers of the thin-film electro-luminescence display module 50 is preferably light-transmittable in order not to influence the original function of the rearview mirror or windscreen.

For example, the conductive lines 30 can be made of metal such as silver or aluminum or light-transmitting conductive material such as indium-tin oxide (ITO). The material for forming the back electrode layer 21 or 52 can be silver or graphite or indium-tin oxide (ITO). The material for forming the dielectric layer 22 or 53 can be barium titanate. It is to be noted that the dielectric layer can be omitted in some special applications. The material for forming the light-transmitting conductive layer 24 or 55 can be indium-tin oxide (ITO). The material for forming the light-emitting layer 23 can be phosphorus (type 20 or type 40) or zinc sulfide:manganese (ZnS:Mn). As for the light-transmitting protective films, they can be made of PET (polyethylene terephthalate) resin.

While the invention has been described in terms of what are presently considered to be the most practical and preferred embodiments, it is to be understood that the invention need not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A thin film display, comprising:
a light-emitting layer for emitting light in response to an alternate current voltage;
a back electrode layer disposed at a side of said light-emitting layer; and
a light-transmitting conductive layer disposed at another side of said light-emitting layer opposite to said back electrode layer, and cooperating with said back electrode layer to provide said alternate current voltage for said light-emitting layer,
wherein said light-emitting layer and said light-transmitting conductive layer are patterned to define a plurality of independent display zones, and when said alternate current voltage is applied between said back electrode layer and said light-transmitting conductive layer in a specified portion of said display zones, light is emitted by said light-emitting layer in said specified portion of display zones to show a specific character.

2. The thin film display according to claim 1 further comprising a dielectric layer formed between said back electrode layer and said light-emitting layer.

3. The thin film display according to claim 1 wherein said light-transmitting conductive layer, said light-emitting layer and said back electrode layer are formed on a transparent substrate of a vehicle.

4. The thin film display according to claim 3 wherein said transparent substrate is a rearview mirror or windscreen.

5. The thin film display according to claim 1 further comprising a control circuit electrically connected to said light-emitting layer and said light-transmitting conductive layer, determining said specified portion of display zones according to said specific character to be shown, and selectively providing said alternate current voltage for said specified portion of display zones.

6. The thin film display according to claim 1 further comprising:
a lower light-transmitting protective film formed on said back electrode layer; and
an upper light-transmitting protective film formed on said light-transmitting conductive layer.

7. The thin film display according to claim 1 wherein said light-emitting layer is an electro-luminescence (EL) layer.

8. The thin film display according to claim 1 wherein said independent display zones include a plurality of sets of seven-segment display zones.

9. A thin film electro-luminescence (EL) display module, comprising:
a light-emitting layer for emitting light in response to an alternate current voltage;
a back electrode layer disposed at a side of said light-emitting layer;
a light-transmitting conductive layer disposed at another side of said light-emitting layer opposite to said back electrode layer, and cooperating with said back electrode layer to provide said alternate current voltage for said light-emitting layer, said light-emitting layer and said light-transmitting conductive layer being patterned to define a plurality of independent display zones;
a flexible and light-transmitting housing for accommodating therein said back electrode layer, said light-emitting layer and said light-transmitting conductive layer; and
a control circuit electrically connected to said light-emitting layer and said light-transmitting conductive layer, determining said specified portion of display zones according to a specific character to be shown, and selectively providing said alternate current voltage for said specified portion of display zones to show said specific character.

10. The thin film EL display according to claim 9 further comprising a dielectric layer formed between said back electrode layer and said light-emitting layer.

11. The thin film EL display according to claim 10 wherein said light-transmitting conductive layer, said light-emitting layer, said dielectric layer and said back electrode layer are formed on a transparent substrate of a vehicle.

12. The thin film EL display according to claim 11 wherein said transparent substrate is a rearview mirror or windscreen.

13. The thin film EL display according to claim 9 wherein said flexible and light-transmitting housing comprises:
a lower flexible and light-transmitting protective film formed on said back electrode layer; and
an upper flexible and light-transmitting protective film formed on said light-transmitting conductive layer.

14. The thin film EL display according to claim 13 wherein said lower and upper flexible and light-transmitting protective films are made of PET (polyethylene terephthalate) resin.

15. A vehicular rearview mirror, comprising:
a reflective mirror for showing image of an object; and
at least one thin-film display unit attached to said reflective mirror for showing an active information,
wherein said thin-film electro-luminescence display unit comprises a plurality of independent display zones, said plurality of independent display zones are selectively activated to emit light so as to show a specific character.

16. The vehicular rearview mirror according to claim 15 wherein said thin-film electro-luminescence display unit comprises:
a light-emitting layer for emitting light in response to an alternate current voltage;
a back electrode layer disposed at a side of said light-emitting layer; and
a light-transmitting conductive layer disposed at another side of said light-emitting layer opposite to said back electrode layer, and cooperating with said back electrode layer to provide said alternate current voltage for said light-emitting layer,
wherein said light-emitting layer and said light-transmitting conductive layer are patterned to define said plurality of independent display zones, and when said alternate current voltage is applied between said back electrode layer and said light-transmitting conductive layer in a specified portion of said display zones, light is emitted by said light-emitting layer in said specified portion of display zones to show said specific character.

17. The vehicular rearview mirror according to claim 15 further comprising a dielectric layer formed between said back electrode layer and said light-emitting layer, and said light-transmitting conductive layer, said light-emitting layer, said dielectric layer and said back electrode layer are formed on said reflective mirror.

18. The vehicular rearview mirror according to claim 15 wherein said specified portion of display zones is determined by a built-in control circuit.

19. The vehicular rearview mirror according to claim 15 wherein said specified portion of display zones is determined by a card inserted into said vehicular rearview mirror.

20. The vehicular rearview mirror according to claim 15 comprising a plurality of thin-film display units attached to different positions of said reflective mirror for showing different active informations.
